(19) United States
(12) Patent Application Publication
(10) Pub. No.: US 2011/0239848 A1
(43) Pub. Date: Oct. 6, 2011

(54) ELECTRONIC MUSICAL INSTRUMENT

(76) Inventor: Idan Beck, Cupertino, CA (US)

(21) Appl. No.: 12/753,670

(22) Filed: Apr. 2, 2010

(51) Int. Cl. G10H 3/18

(52) U.S. Cl. 84/726

(57) ABSTRACT

Embodiments of the invention provide an electronic musical instrument. The electronic musical instrument comprises a base and a switch array disposed on the base. The switch array comprises multiple contacts disposed on the base and multiple strings suspended over the contacts. The array is configured to generate input signals by pressing the strings over the contacts. The electronic instrument further comprises a processor coupled to the switch array. The processor is configured to receive the input signals and generate output signals, wherein the output signals correspond to musical note information.

### FIELD OF THE INVENTION

The invention relates to musical instruments and more specifically the invention relates to electronic musical instruments.

### BACKGROUND OF THE INVENTION

Various electronic musical instruments are known for producing music. Examples of electronic musical instruments include musical keyboards, guitar or guitar-like instruments and so forth. The electronic musical instruments generate electric signals for producing musical notes. Such devices may be used in, for example, musical performances or for playing video games.

Generally, the guitar or guitar-like electronic musical instruments are string-less and include mechanical keys to generate musical notes. For example, a published U.S. patent application Ser. No. 12/383,750 assigned to Clifford S. Elion, discloses an electronic fingerboard for a stringed instrument. The strings are either embossed on the neck of the guitar or are non-existent. Some techniques as described in U.S. patent Publication No. assigned to Ser. No. 12/115,519 assigned to Starr Labs Inc., implements keys on the neck of the guitar and strings for note articulation.

Another technique for a string-less guitar is described in PCT Application No. WO/2009/111815 by Michael Zarimis. The invention describes an array of touch sensitive sensors or buttons that comprise virtual strings. Yet another guitar-style synthesizer-controller having touch-sensitive switches is disclosed in U.S. Pat. No. 5,085,119 assigned to John F. Cole. However, the controller does not have an interface similar to a real guitar. Moreover, the controller is not completely digital as the inputs from the users are detected by using transducers and converted to digital signals. Therefore, guitar-like instruments may have a body in the shape of a guitar, but do not provide an interface of a real guitar. Moreover, pressing the buttons or keys only simulates the playing of a guitar. Further, various advanced functions like string bending and strumming may not be effectively performed on such musical instruments.

Various techniques are available that provide stringed electronic musical instruments. For example, U.S. Pat. No. 7,563,977 assigned to iGuitar, Inc., describes a stringed guitar that can generate electric signals. However, the musical instrument as described requires transducers to sense the vibration of the strings to generate analog signals. Further, the analog signals are required to be converted to digital signals for example, MIDI or streaming audio. Thereafter, an external device processes the digital signals to produce musical notes. The actual capturing of inputs from a user till generation of output requires devices such as transducers, analog-to-digital convertors that process the input. As a result, the conversion to a MIDI signal incurs a considerable latency and this technique may not be consistent or reliable for real-time use such as video games.

Another technique as described in U.S. Pat. No. 4,658,690 assigned to Synthaxe Limited, discuss an electronic guitar with two separate sets of strings. One set of strings is provided on a fretboard to sense pitch bending. Sensing of pitch bending is accomplished by coils embedded in the neck of the guitar, which sense the change of electromagnetic fields generated by the current in the strings. The other set of strings, which is offset from the set of strings on the fretboard, are used to trigger the sensing of the strings on fretboard. Further, the technique provides keys or buttons on the body of guitar to trigger the six strings on fretboard. However, the strings used for triggering being separate from the strings on the fretboard, are difficult to use and do not provide interface and feel of a real guitar. Moreover, in practice most users generally use the six keyboard keys embedded into the body to trigger the strings.

Various digital guitars are also used as video game controllers, for playing video games such as Guitar Hero®. These game controllers have shape of guitars. However, these game controllers have most of the limitations as discussed above. A guitar shaped game controller is disclosed in a published U.S. patent application Ser. No. 12/020,465 assigned to Lee Guinchard. The guitar shaped controller includes buttons on fretboard for playing games. Therefore, a real interface of guitar is not provided, which undermines the experience of the user. A stringed game controller in shape of a guitar is disclosed in a published U.S. patent application Ser. No. 12/359,237 assigned to Bernard Chiu et al. The game controller may also be used as a musical instrument. The game controller has a stringed interface like an electric guitar, however it requires sensing of movement of the strings by pick-up coils to generate output signals. The signals may then be used to control games or generate music. Therefore, the controller functions as an electric guitar and is not completely digital. As a result, there are time delays between actuation of strings and generation of output signals, which makes it difficult for the user to co-ordinate with the games accurately or play various types of music.

Therefore, the existing techniques do not effectively provide the interface, functionalities and experience of using a real guitar. Moreover, the techniques provide limited ways of connecting the musical instruments to external devices. Furthermore, the existing techniques may be expensive due to complexity of design and hardware involved.

### SUMMARY

The present invention provides an electronic musical instrument. The electronic musical instrument comprises a body and a switch array disposed on the body. The switch array comprises multiple contacts disposed on the body and multiple strings suspended over the contacts. The array is configured to generate input signals by pressing the strings over the contacts. The electronic instrument further comprises a processor coupled to the switch array. The processor is configured to receive the input signals and generate output signals, wherein the output signals correspond to musical note information.

The invention further provides an electronic musical instrument. The electronic musical instrument comprises a body portion and a neck portion detachably connected to the body. The electronic musical instrument further comprises a switch array disposed on the body and the neck, wherein the switch array comprises a plurality of contacts disposed on the body and a plurality of strings suspended over the contacts. The array is configured to generate one or more digital input signals by pressing the one or more strings over the one or more contacts. Further, the electronic musical instrument comprises a processor disposed on the neck and coupled to the switch array, wherein the processor is configured to receive the input signals and generate one or more digital output signals.

The invention further provides a method for processing inputs provided by a user on an electronic musical instrument. The method comprises receiving one or more digital input signals from a switch array, wherein the switch array is configured to produce the input signals in response to the user pressing one or more strings on one or more contacts on the musical instrument. The method further comprising generating one or more digital output signals by a processor based on the input signals, wherein the output signals correspond to musical note information.

An aspect of the invention is to provide an interface like that of a real stringed instrument to the user.

Another aspect of the invention is to identify the inputs of the user digitally to generate musical note information.

Yet another aspect of the invention is to communicate bi-directionally with external devices.

Still another aspect of the invention is to sense touching of strings by a user on the instrument.

### BRIEF DESCRIPTION OF THE DRAWINGS

Having thus described the invention in general terms, reference will now be made to the accompanying drawings, which are not necessarily drawn to scale, and wherein:

FIG. 1 illustrates an exemplary environment where various embodiments of the invention function;

FIG. 2 illustrates an exemplary architecture of an electronic musical instrument, in accordance with an embodiment of the invention;

FIG. 3 illustrates an exemplary arrangement of various components of the electronic musical instrument, in accordance with an embodiment of the invention;

FIGS. 4a and 4b illustrate exemplary view with a neck and a body of electronic musical instrument connected, in accordance with an embodiment of the invention;

FIG. 5 illustrates exemplary view with the neck and the body of electronic musical instrument disconnected, in accordance with an embodiment of the invention; and

FIG. 6 is an exemplary connectivity architecture of the electronic musical instrument with external devices, in accordance with an embodiment of the invention.

### DETAILED DESCRIPTION OF THE INVENTION

Illustrative embodiments of the invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

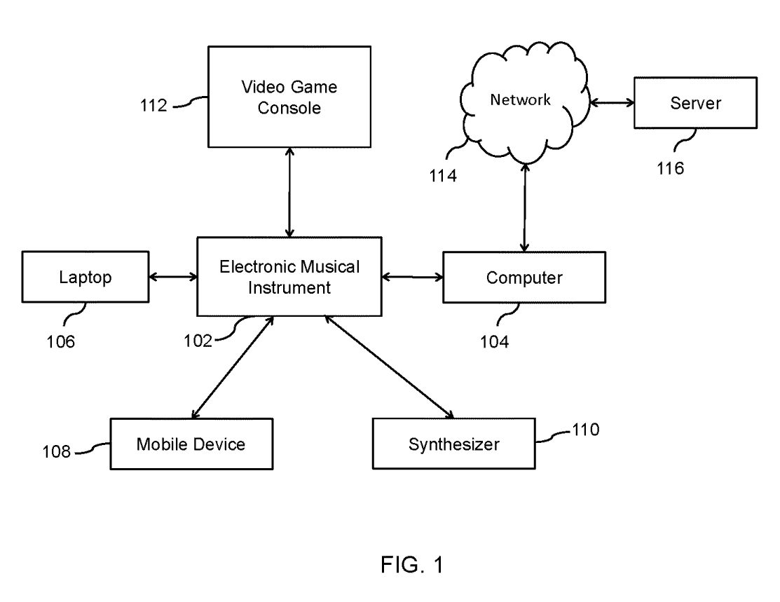

With reference to FIG. 1 an exemplary environment is illustrated where various embodiments of the invention function. A user may use an electronic musical instrument 102 to generate electric signals. Examples of instrument 102, here after referred to as Etar 102 include, but are not limited to, instruments that look like a guitar, a violin, viola, cello or any other stringed musical instrument. The electric signals generated by Etar 102 may correspond to musical information. For example, the electric signal may include Musical Instrument Digital Interface (MIDI) signals. Furthermore, electric signals may be used to control video games. Etar 102 may communicate with various external devices through interfaces such as, but not limited to, Universal Serial Bus (USB), Recommended Standard (RS) 232, Registered Jack (RJ) 45, or other wired or wireless interfaces such as Bluetooth or Radio Frequency (RF).

As shown in FIG. 1, Etar 102 may communicate with a computer 104, a laptop 106, a mobile device 108, a synthesizer 110, and a video game console 112. Mobile device 108 may be for example, a mobile phone, a smart phone, a Personal desktop Assistant (PDA) and so forth. Furthermore, Etar 102 may be connected to a server 116 through a network 114 and computer 104. Examples of network 410 include, but are not limited to, a Local Area Network (LAN), Wide Area Network (WAN), Wireless network (Wifi), a mobile network, the Internet and so forth. Only a limited type of external devices are illustrated, however a person skilled in the art will appreciate that other type of devices that use standard means of communication can also be connected to Etar 102. Etar 102 may be used to control the external devices, for example, transmit musical note information or play a video game executing on an external device. Etar 102 generates digital signals based on inputs provided by the user. The digital signals may be transmitted to the external devices. Moreover, Etar 102 can receive information from the external devices. For example, Etar 102 can be controlled or configured through external devices. Therefore, Etar 102 can function as a bi-directional device.

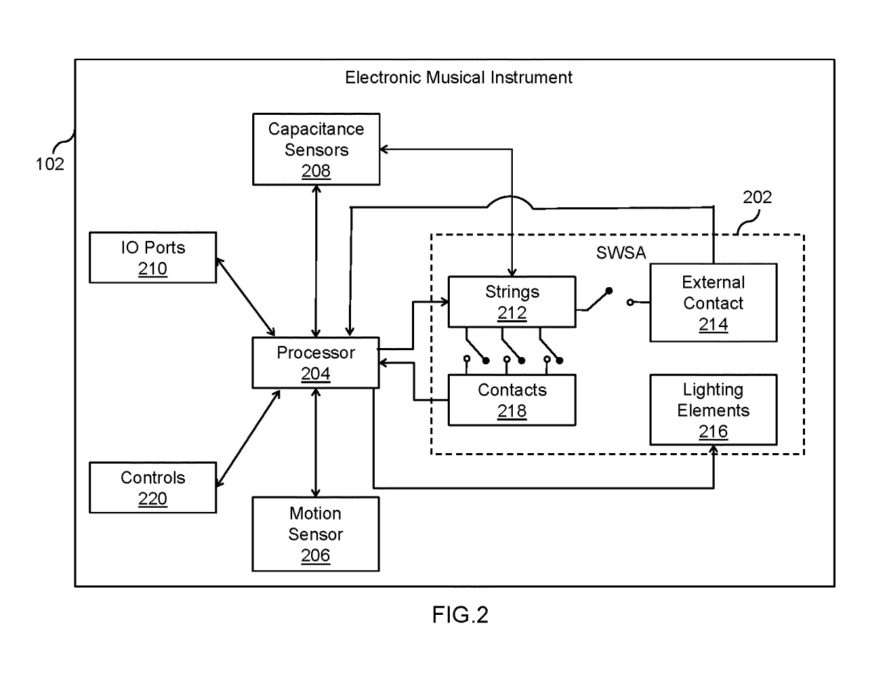

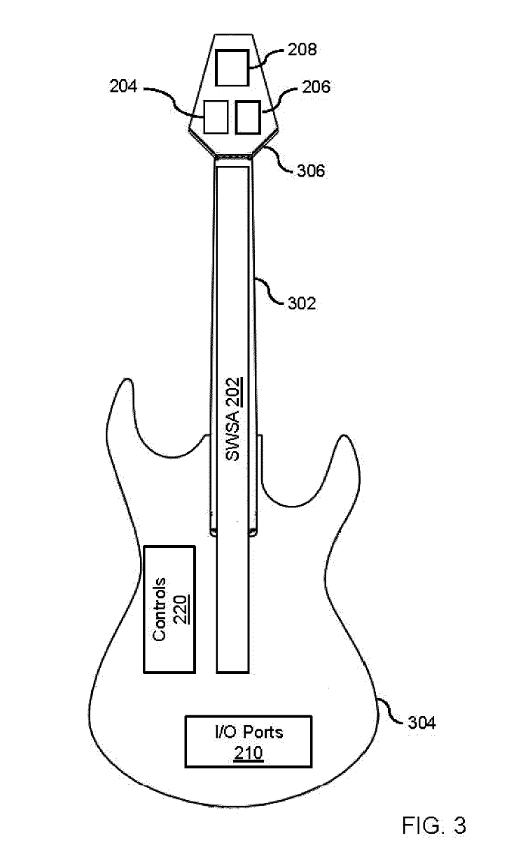

With reference to FIG. 2 an exemplary architecture of Etar 102 is illustrated. Etar 102 may include a base. For example, in case Etar 102 has a shape of a musical instrument such as a guitar, than base may include a neck and a body. Etar 102 includes a Suspended Wire Switch Array (SWSA) 202 that may be used by the user to provide inputs to Etar 102. SWSA 202 includes contacts 218, strings 212, external contacts 214, and lighting elements 216. Contacts 214 are disposed on the body of Etar 102, and strings 212 are suspended over contacts 214. For example, in case Etar 102 has a shape of guitar containing a neck and a body, then contacts 214 may be arranged over the neck and strings 212 may be suspended over contacts 214. A typical arrangement of various components of Etar 102 is illustrated with reference to FIG. 3. Etar 102 may be connected to a power source to allow for operation of Etar 102. The power source may include an external or internal power source, or onboard power system such as batteries, or other power generation means. In an embodiment of the invention, Etar 102 may be powered from a USB connection.

The user may press one or more strings 212 to touch one or more contacts 214 for providing inputs. Strings 212 may be polled for inputs provided by the user. For example, the polling may be performed by sequentially or periodically transmitting signals through strings 212, while contacts 214 act as sink for the signals. Therefore, when the user presses a string to touch a contact, then a circuit is completed and SWSA 202 generates digital inputs signals. Furthermore, the user may touch external contact 214 to one or more strings 212 to provide inputs. External contact 214 may be for example, a metal pick in case of a guitar. External contact 214 may be connected through wire or wirelessly to Etar 102. The detailed functioning and architecture of SWSA is also explained in a U.S. patent application Ser. No. 12/634,377, filed on Dec. 9, 2009 by the inventor of this invention, and is incorporated herein in its entirety by reference. Furthermore, lighting elements 216 may be provided on the body or neck of Etar 102. Lighting elements 216 may include for example, light emitting diodes, that light up to provide a visual feedback about the mode of Etar 102 to the user. The mode may include a musical instrument mode, a game controller mode, a standby mode and so forth. Moreover, the external devices connected to Etar 102 may control lighting elements 216. A processor 204 receives the digital input signals generated by SWSA 202.

Processor 204 is disposed on the neck of Etar 102. In an embodiment of the invention, processor 204 may be disposed on the body of Etar 102. Processor 204 may be connected to capacitance sensors 208 and motion sensor 206. Capacitance sensors 208 may also be connected to strings 212 to sense touching of the strings by the user. Therefore, when the user touches any string a digital signal is transmitted to processor 204 by capacitance sensors 208. The detection of touch may be used for advanced guitar playing techniques such as guitar muting. Motion sensor 206 enables detection of orientation of Etar 102. Motion sensor 206 may be for example, a three axes and low gravity accelerometer. Motion sensor 206 transmits digital signals to processor 204 based on the orientation of Etar 102. Therefore, the user can provide inputs to Etar 102 by moving or rotating it. Processor 204 processes the signals received from strings 212, capacitance sensors 208 and motion sensor 206 to generate digital output signals. The digital output signals may correspond to musical note information. For example, the output digital signal may be MIDI signals based on the strings and notes selected by the user, and/or the orientation of Etar 102. The input signals are in a digital format; therefore output digital signals can be generated directly without any analog-to-digital or digital-to-analog conversion. As a result, the processing of the signals is faster, efficient, and without any delay or lag between the inputs provided by the user and output generated by Etar 102. Therefore, the user is provided with an experience of playing an instrument with an interface similar to that of a real instrument with efficient output. In an embodiment of the invention, the output signals may be analog signals.

Processor 204 may be connected to multiple Input/Output (IO) ports 210. The output signals generated by processor 204 are transmitted to the external devices through IO ports 210. Moreover, IO ports 210 may receive external signals from the external devices. Thereafter, processor 204 may process the external signals. The external signals may include signals to control or configure Etar 102. For example, processor 204 may receive signals from the external devices to control lighting elements 216. Therefore, Etar 102 functions as a bi-directional communication device. Examples of IO ports 210 include, but are not limited to USB, Firewire, RS232, RJ45, or other wired or wireless communication means such as RF or Bluetooth. IO ports 210 may be disposed on the body and processor 204 may be disposed on the neck of Etar 102. Further, the body may include controls 220 to control various features or modes of Etar 102. For example, the user may control the volume output, the mode of Etar 102, and other features from controls 220.

The body of Etar 102 may be detachable from the neck. Therefore, the body of Etar 102 can be customized based on the number and types of functionalities, and then connected to the neck. Further, processor 204 may automatically detect the number and types of IO ports 210 available in the body. For example, the user may not require a Firewire port, but requires an additional USB port, therefore, only the body of Etar 102 may be customized to meet the user's requirement. As a result, the user may have many options available to personalize Etar 102. In an embodiment of the invention, the body of Etar 102 may include a display for displaying information to the user. For example, the display may present the volume, connection with the external devices, power status, and so forth. Examples of the display include, but are not limited to, a Liquid Crystal Display (LCD), Light Emitting Diode (LED) display and so forth. Therefore, the user can buy different bodies based on the configuration required and hot-swap or replace the existing body without any significant interruption to functioning of Etar 102. As a result, Etar 102 is extremely customizable.

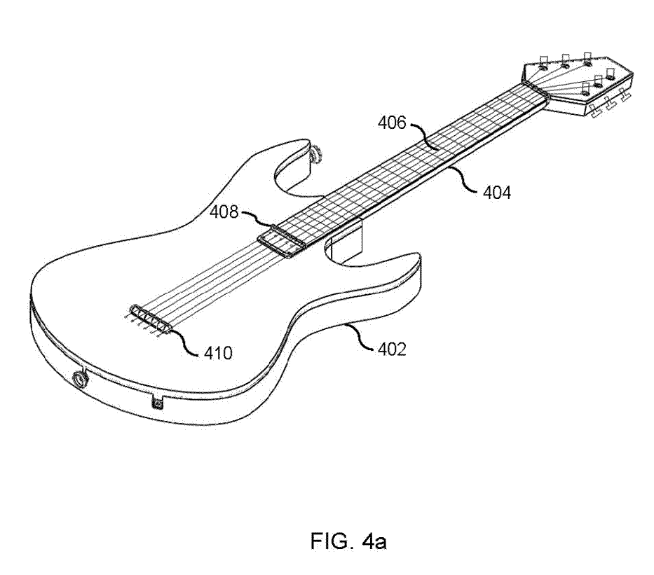

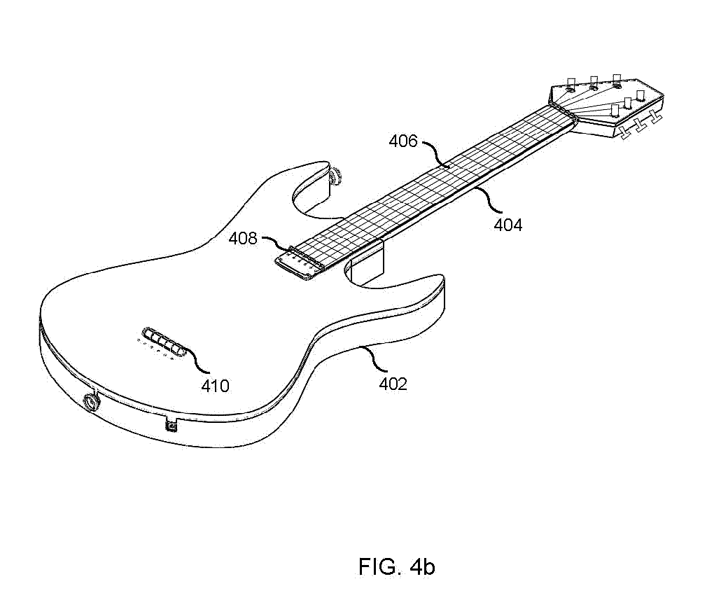

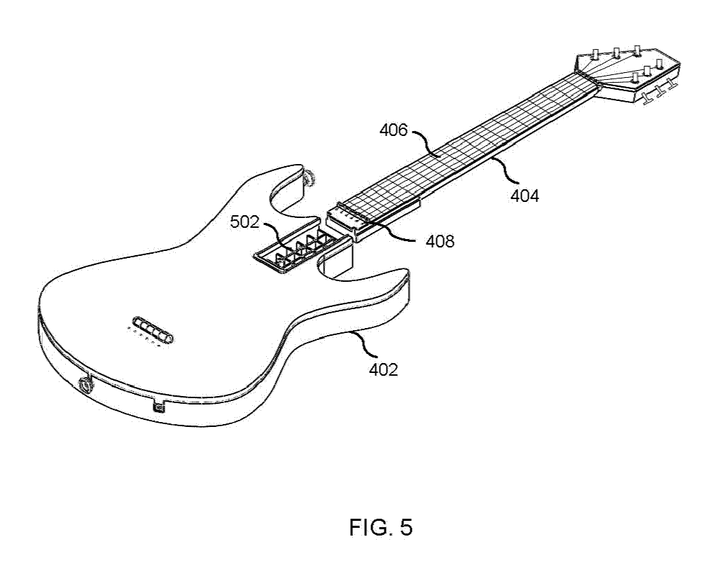

FIG. 3 illustrates an exemplary arrangement of the various components of Etar 102. As discussed with reference to FIG. 2, Etar 102 may include a neck 302, a body 304 and a headstock 306. Neck 302 may be electrically connected to body 304. Moreover, neck 302 can be detached from body 304. For example, neck 302 and body 304 may be connected through a customized expansion port. The connected and disconnected neck and body of Etar 102 are explained with reference to FIG. 4a-b, and FIG. 5. In an embodiment of the invention, neck 302 and body 304 may be integrated and non-detachable. As shown in FIG. 3, SWSA 202 may be disposed on neck 302. Moreover, strings 212 of SWSA 202 may be disposed on neck 302 and terminated on a bridge (not shown) on body 304, as in case of a standard stringed instrument such as a guitar. Further, processor 204, capacitance sensors 208, and motion sensor 206 may be disposed on headstock 306. Body 304 may include IO ports 304 and controls 220. As discussed with reference to FIG. 2, the number and type of IO ports 304 can be customized based on the requirements of the user. Therefore, Etar 102 may present an interface that looks like a real stringed instrument to the user. A person skilled in the art will appreciate that the position of the various components maybe exemplary, and various other arrangements are possible.

With reference to FIG. 4a, a neck 404 and a body 402 of Etar 102 are illustrated in a connected configuration. As shown, Etar 102 may include a neck bridge 408 and a body bridge 410 with corresponding holes for connecting strings 406. Neck bridge 408 is disposed on neck 404 and body bridge 410 is disposed on body 402 of Etar 102. Moreover, neck bridge 408 may be removable from neck 404. Therefore, Etar 102 can be customized based on the preferences of the user. For example, the user may remove neck bridge 408 and use body bridge 410.

Therefore, as shown with reference to FIG. 4a, strings 406 may be connected to body bridge 410. Alternatively, strings 406 may be connected to neck bridge 408 as shown with reference to FIG. 4b. A person skilled in the art will appreciate that neck 404 may be designed to be longer than that of a conventional musical instrument such as guitar, for neck bridge 408 to look and function like body bridge 410. When strings 406 are connected to neck bridge 408, the swapping of body 402 with another body becomes easier, as the user may not be required to remove strings 406. The disconnected arrangement of neck 404 and body 406 is illustrated in FIG. 5. As shown, strings 406 are connected to neck bridge 408. Further, body 402 includes a connection mechanism 502, for connecting and disconnecting neck 404 and body 402. Connection mechanism 502 may include mechanism to electrically and mechanically connected neck 404 and body 402. For example, connection mechanism 502 may include a groove and spring mechanism for mechanical connectivity and an expansion port for electrical connectivity of neck 404 and body 402. Therefore, as also discussed above, bodies for Etar 102 can be hot-swapped easily.

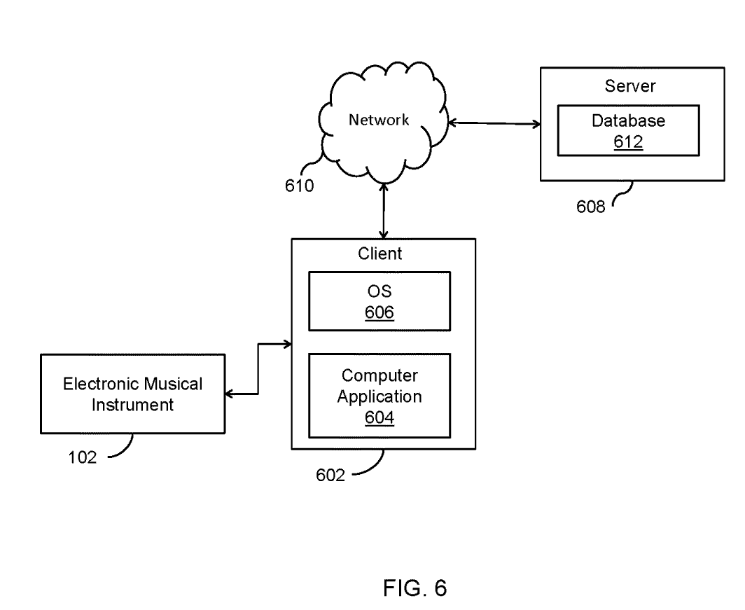

FIG. 6 illustrates an exemplary connectivity architecture of Etar 102 with the external devices is illustrated. As discussed with reference to FIG. 1, the external devices may include a computer, a laptop, a mobile phone, a video game console and so forth. Further the external devices may be connected to other external devices over a network such as the Internet. For example, various video game consoles such as Playstation enables the user to connect to the Internet. Therefore, the user can interface with other users in real-time over the network.

As shown in FIG. 6, Etar 102 may connect and communicate with an external device 602, here after referred to as client 602. Client 602 may include a computer application 604 that receives and/or sends the signals to Etar 102. Computer application 604 may be software or firmware on client 602. Moreover, client 602 may include an Operating System (OS) 606 for executing computer application 604. A person skilled in the art will appreciate that computer application 604 may be implemented directly on hardware of client 602; therefore OS 606 may not be required. Computer application 604 may process the output signals from Etar 102 to generate musical notes. Moreover, computer application 604 may process the output signals from Etar 102 to control other application such as a video game on client 602 or over the network.

Client 602 may be connected to a server 608 through a network 610 or cloud based services. Examples of network 610 include, but are not limited to, a Local Area Network (LAN), Wide Area Network (WAN), Wireless network (Wifi), a mobile network, the Internet and so forth. Server 608 may include computer applications and a database 612 to enable communication with various clients. Therefore, client 602 may connect to the application available on server 608, or connect to other clients through server 608. As a result, the user can interface or compete with other users in real-time. Furthermore, computer application 604 on client 602 may be used to control or configure Etar 102. For example, lighting elements of Etar 102, the mode of Etar 102 may be controlled from computer application 604. Moreover, computer application 604 can configure the programming of components of Etar 102, such as processor 204. For example, the firmware or software of processor 204 may be configured or upgraded from computer application 604 of client 602.

With the above components and design thereof in mind, it should be appreciated that alternative components, constructions and materials can be used to accomplish the benefits derived from Etar 102. For example, Etar 102 may comprise more than one processor.

Having discussed the exemplary embodiments and contemplated modifications, it should be appreciated that a method for processing inputs provided by a user on an electronic musical instrument is also contemplated. According to this method, an electronic musical instrument is provided. The electronic musical instrument, here after referred to as Etar, may include a Suspended Wire Switch Array (SWSA), a processor, multiple Input/Output (IO) ports, one or more capacitance sensors and a motion sensor.

The user touches strings to press contacts of the SWSA to generate digital input signals. Moreover, digital input signals are generated based on sensing of touch by the capacitance sensors. Furthermore, digital input signals are generated based on sensing of orientation of the Etar by the motion sensor. The digital input signals are received by the processor that processes the input signals to generate digital output signals. The output digital signals correspond to musical note information. For example, the musical note information may include MIDI signals.

Further, the output signals are transmitted through the IO ports to external devices. Thereafter, the external devices generate musical notes based on the output signals. The external devices may also transmit digital signals for controlling or configuring the Etar. The user is provided a visual feedback based on the function or mode of the Etar, through lighting elements connected to the processor. Additionally, the user may control various features such as the volume, or mode of the Etar from controls on the Etar. Moreover, the body of the Etar can be detached from the neck.

While the invention has been described in connection with what is presently considered to be the most practical and various embodiments, it is to be understood that the invention is not to be limited to the disclosed embodiments, but on the contrary, is intended to cover various modifications and equivalent arrangements included within the spirit and scope of the appended claims.

This written description uses examples to disclose the invention, including the best mode, and also to enable any person skilled in the art to practice the invention, including making and using any devices or systems and performing any incorporated methods. The patentable scope the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. An electronic musical instrument comprising:
an instrument base;
a switch array disposed on the base, wherein the switch array comprises a plurality of contacts disposed on the body and a plurality of strings suspended over the contacts, and wherein the array is configured to generate one or more input signals by pressing the one or more strings over the one or more contacts; and
a processor coupled to the switch array and configured to receive the input signals to generate one or more output signals, wherein the output signals correspond to musical note information.

2. The instrument of claim 1, wherein the inputs signals comprise digital signals.

3. The instrument of claim 1, wherein the output signals comprise at least one of digital signals and analog signals.

4. The instrument of claim 1 further comprising one or more lighting elements configured to provide a visual feedback.

5. The instrument of claim 4, wherein the visual feedback comprises a mode of the instrument.

6. The instrument of claim 4, wherein the lighting elements comprise light emitting diodes.

7. The instrument of claim 4, wherein the lighting elements are controlled by the processor.

8. The instrument of claim 1 further comprising one or more capacitance sensors configured to generate one or more input signals based on detecting a touch on the strings.

9. The instrument of claim 1 further comprising one or more motion sensors configured to provide one or more input signals corresponding to one or more orientations of the instrument.

10. The instrument of claim 9, wherein the input signals from the motion sensors are received by the processor.

11. The instrument of claim 1 further comprising one or more input/output ports coupled to the processor, wherein the input/output ports are configured to transmit the output signals to one or more external devices.

12. The instrument of claim 11, wherein the output signals are transmitted wirelessly.

13. The instrument of claim 11, wherein the input/output ports are configured to receive one or more external digital signals from the external devices to control the instrument.

14. The instrument of claim 11, wherein the digital signals are transmitted wirelessly to the external devices.

15. The instrument of claim 11, wherein the external device comprises a computer application to control the musical instrument.

16. The instrument of claim 1, wherein the switch array further comprising an external contact configured to generate the one or more input signals by pressing the one or more strings.

17. An electronic instrument in shape of a guitar comprising:
a body portion;
a neck portion detachably connected to the body;
a switch array disposed on the body and the neck, wherein the switch array comprises a plurality of contacts disposed on the body and a plurality of strings suspended over the contacts, and wherein the array is configured to generate one or more digital input signals by pressing the one or more strings over the one or more contacts; and
a processor disposed on the neck and coupled to the switch array, wherein the processor is configured to receive the input signals and generate one or more digital output signals.

18. The instrument of claim 17, wherein the body comprises one or more input/output ports coupled to the processor, wherein the input/output ports are configured to transmit the output signals to one or more external devices.

19. The instrument of claim 17, wherein the neck further comprising one or more capacitance sensors coupled to the processor, wherein the capacitance sensors are configured to generate one or more input signals based on detecting a touch on the strings.

20. The instrument of claim 17, further comprising an accelerometer coupled to the processor, wherein the accelerometer is configured to provide one or more input signals corresponding to one or more orientations of the musical instrument.

21. The instrument of claim 17, wherein the switch array further comprising an external contact configured to generate the one or more input signals by pressing the one or more strings.

22. The instrument of claim 17, wherein the output signals correspond to musical note information.

23. The instrument of claim 17, wherein the output signals correspond to game control information.

24. A method for processing inputs provided by a user on an electronic musical instrument comprising:
receiving one or more digital input signals from a switch array, wherein the switch array is configured to produce the input signals in response to the user pressing one or more strings on one or more contacts on the musical instrument; and
generating one or more digital output signals by a processor based on the input signals, wherein the output signals correspond to musical note information.

25. The method of claim 24 further comprising providing a visual feedback by one or more lighting elements on the musical instrument.

26. The method of claim 24, wherein the visual feedback comprises a mode of the musical instrument.

27. The method of claim 24 further comprising receiving one or more input signals from a capacitive sensor, wherein the sensor generates the input signals by detecting touch on the strings of the instrument.

28. The method of claim 24 further comprising receiving one or more input signals from a motion sensor, wherein the motion sensor generates the input signals corresponding to one or more orientations of the instrument.

29. The method of claim 24 further comprising transmitting the input signals to the processor.

30. The method of claim 24 further comprising transmitting the input signals to one or more external devices.

31. The method of claim 24 further comprising providing the output signals to one or more external devices.

32. The method of claim 24, further comprising:
receiving digital signals from one or more external devices; and
controlling the musical instrument based on the received signals.
